(19) United States
(12) Patent Application Publication
(10) Pub. No.: US 2026/0216639 A1
(43) Pub. Date: Jul. 30, 2026

(54) Reusable Materials for Air Dehumidification and Moisture Removal that is Regenerable by Mechanical Means

(71) Applicant: THE HONG KONG UNIVERSITY OF SCIENCE AND TECHNOLOGY, Hong Kong (CN)

(72) Inventors: King Lun YEUNG, Hong Kong (CN); Jiayu SONG, Hong Kong (CN); Zhang LIU, Hong Kong (CN)

(21) Appl. No.: 19/146,169

(22) PCT Filed: Jan. 17, 2024
(86) PCT No.: PCT/CN2024/072720

§ 371 Date: Jul. 7, 2025

Related U.S. Application Data
(60) Provisional application No. 63/480,296, filed on Jan. 18, 2023.

(51) Int. Cl. B01D 53/28; B01D 53/26; B01J 20/24; B01J 20/32; B01J 20/34; E03B 3/28

(52) U.S. Cl. CPC B01D 53/28; B01D 53/261; B01J 20/24; B01J 20/3204; B01J 20/3268; B01J 20/3425; B01J 20/3491; E03B 3/28; B01D 2253/106; B01D 2253/202; B01D 2253/25; B01D 2257/80; B01D 2259/40083

(57) ABSTRACT

An atmospheric water harvester includes: a hygroscopic polymer; and a hydrophobic matrix whereby the hygroscopic polymer is embedded in the hydrophobic matrix. In a particular embodiment, the hygroscopic polymer is chitosan and the hydrophobic and elastic matrix is silica xerogel. Further, a method of harvesting water from an atmosphere includes the steps of providing an atmospheric water harvester in an atmosphere, capturing water on the hygroscopic polymer by exposing the atmospheric water harvester to water vapor in the atmosphere for a period of time, and mechanically removing the captured water from the atmospheric water harvester after the period of time. The period of time ranges from 1 day to 30 days, the hygroscopic polymer is chitosan, and the hydrophobic matrix is made of silica xerogel.

### BACKGROUND

### 1. Field

The present disclosure relates to air dehumidification and moisture removal, in particular to reusable materials for air dehumidification and moisture removal that is regenerable by mechanical means.

### 2. Description of the Related Art

Global freshwater scarcity is getting more severe due to increasing population growth, global climate change, and water-quality deterioration. One sustainable water resource is the water preserved in the atmosphere, equivalent to 10% of the water in all lakes on the planet. Harvesting the atmospheric moisture is a promising approach to alleviate the freshwater crisis. In addition, harvesting atmospheric moisture plays an essential role in controlling indoor humidity to maintain comfortable living conditions. The potential technologies of atmospheric water harvesting include fog collection, a cooling-based atmospheric water harvester (AWH), and a sorption-based AWH. Fog collection involves binding liquid-phase water clusters in the air to form big droplets, which are collected by gravity force. This form of moisture harvesting has a strict requirement to the geometrical and climatic conditions (e.g., temperature, wind, and humidity).

A cooling-based AWH, on the other hand, involves condensing atmospheric water vapor to the liquid phase, but is limited by its intensive energy consumption and high costs. For example, an air conditioner, a typical cooling-based AWH, consumes nearly 20% of the electricity used in buildings worldwide.

In this regard, sorption-based AWH has attracted much attention in recent years for economical and sustainable atmospheric water harvesting. The general working principle of sorption-based atmospheric water harvester is that the adsorbents capture moisture in the air and subsequently release water in the form of liquid. An issue with sorption-based AWHs is that the release process usually requires thermal energy consumption. For example, the commonly used zeolites and aluminosilicate minerals can absorb water easily, but liberating the water molecules may require temperatures of 250° C. owing to their strong interaction with water. To improve the desorption capability of sorbents with low energy consumption, recent work has focused on the metal-organic framework (MOF) by modifying its framework topology and the linker size. Owing to the low desorption enthalpy, MOFs-based AWH can be regenerated by low-grade energy such as solar irradiation for green and sustainable water production.

An alternative sorption-based AWH is developed by confining hygroscopic salts like LiCl and CaCl₂) in a host matrix such as polymer networks and porous materials. Also, taking advantage of the solar-thermal effect, the hygroscopic salt AWH systems are further upgraded with the decoration of carbon materials (like carbon fibers, carbon nanotubes, and graphene) due to their high thermal conductivity and superior light adsorption efficiency. In a typical solar-driven water harvesting process, the adsorbents capture water from the atmosphere through adsorption at night and release freshwater through desorption condensation during the day with natural sunlight radiation. Even though this process requires no extra energy consumption, it is still bounded by the availability and intensity of solar radiation and quite a long desorption time (several hours).

### SUMMARY

Therefore, there is a need for an atmospheric water harvester that addresses the problems and disadvantages of current atmospheric water harvesters. Therefore, in an embodiment of the present subject matter, an atmospheric water harvester includes: a hygroscopic polymer; and a hydrophobic matrix. In this embodiment, the hygroscopic polymer is embedded in the hydrophobic matrix.

In a particular embodiment, the hygroscopic polymer is chitosan and the hydrophobic and elastic matrix is silica xerogel.

In a further embodiment, the present subject matter is drawn to a method of harvesting water from an atmosphere. The method includes the steps of providing an atmospheric water harvester in an atmosphere, capturing water on the hygroscopic polymer by exposing the atmospheric water harvester to water vapor in the atmosphere for a period of time; and mechanically removing the captured water from the atmospheric water harvester after the period of time. The atmospheric water harvester includes a hygroscopic polymer and a hydrophobic matrix, wherein the hygroscopic polymer is embedded in the hydrophobic matrix.

In a particular embodiment, the period of time ranges from 1 day to 30 days, the hygroscopic polymer is chitosan, and the hydrophobic matrix is comprised of silica xerogel.

### BRIEF DESCRIPTION OF THE DRAWINGS

FIG. 1 is a schematic diagram of the synthesis of chitosan-silica xerogel in accordance with an embodiment of the present disclosure.

FIG. 2(a) is a photo of the as-prepared chitosan-silica xerogel. FIG. 2(b) is a SEM image of the chitosan-silica xerogel. FIG. 2(c) is an EDXS spectra of spherical particles (site A). FIG. 2(d) is an EDXS spectra of particles with irregular shapes (site B).

FIG. 3 depicts an FTIR spectra of chitosan-silica xerogel, silica xerogel and chitosan.

FIG. 4(a)-(c) depict water contact angles on (a) silica xerogel, (b) chitosan-silica xerogel and (c) chitosan (high)-silica xerogel.

FIG. 5(a)-(c) show stress-strain curves of (a) silica xerogel, (b) chitosan-silica xerogel, and (c) chitosan (high)-silica xerogel.

FIG. 6. Is a schematic drawing of an experimental setup of the water harvesting test.

FIG. 7(a) are photos showing the chitosan-silica xerogel status on different water harvesting days. FIG. 7(b) depicts water capture and release performance of the chitosan-silica xerogel.

Similar reference characters denote corresponding features consistently throughout the attached drawings.

### DETAILED DESCRIPTION OF THE PREFERRED EMBODIMENTS

The present disclosure is drawn to a sorption-based atmospheric water harvester (AWH) composed of hygroscopic polymer incorporated in a hydrophobic and elastic matrix. In a particular embodiment, the hygroscopic polymer is chitosan and the hydrophobic matrix is comprised of silica xerogel. However, it is contemplated that other hygroscopic polymers can be used in the atmospheric water harvester of the present disclosure, for example. In addition, other hydrophobic and elastic matrices can be used in the present disclosure. Chitosan and silica xerogel are two non-limiting examples of components usable in the present disclosure.

Another non-limiting example of a hygroscopic polymer usable in the present subject matter is Polyethylene Glycol 4000. However, the selection of chitosan as the hygroscopic material is based on its inherent anti-bacterial activity. Given the requirement for the xerogel to function effectively in a significantly humid environment, preventing the proliferation of bacteria, fungi, and yeasts is crucial to ensure a safe and uncontaminated environment, as well as the purity of the water collected. Another advantage of the chitosan is its cost-effectiveness. Thus, a particular embodiment of the present subject matter has chitosan as the hygroscopic polymer.

Likewise, another non-limiting example of a hydrophobic and elastic material for the matrix is hydrophobilized phenolic xerogel. The selection of silica xerogel as the matrix in a particular embodiment is driven by its exceptional superhydrophobicity (with water contact angle >150°) and simple fabrication procedures. Moreover, the introduction of hygroscopic materials into the silica precursor does not impede the formation of the superhydrophobic silica matrix, thus preserving the desired wettability contrast (hydrophobicity/hydrophilicity) within the silica xerogel.

In accordance with the present atmospheric water harvesters, atmospheric water vapor is attracted by the hygroscopic polymers, condensed, and confined within the hydrophobic matrix. Due to the flexibility and hydrophobicity of the matrix, the existing liquid water inside can be further released by mechanical squeezing. Such mechanical squeezing can be accomplished by hand or by using mechanical means. The present subject matter is not limited to a particular method of mechanical squeezing to remove the captured water from the atmospheric water harvester.

In an embodiment of the present disclosure, the chitosan-silica xerogel monolith of the present disclosure demonstrates a water capturing capability of 86.3 g water/g chitosan at 97% relative humidity (RH) at 25° C. every 30 days, and 88% of the water captured can be released by mechanical compression with stress lower than 0.020 MPa and time consumption less than 150 seconds. The xerogel's water capture and release performance can be maintained for more than two cycles and the matrix is durable for mechanical compression. It was determined that a particular range for chitosan to dimethyldimethoxysilane ratio was 0.05-0.075 g/ml.

In a further embodiment, the present disclosure is directed to a method of harvesting water from an atmosphere. The method includes providing an atmospheric water harvester in an atmosphere. The atmospheric water harvester being provided is in accordance with those described herein, namely the atmospheric water harvester includes a hygroscopic polymer and a hydrophobic matrix in which the hygroscopic polymer is embedded. The method then includes the steps of capturing water on the hygroscopic polymer by exposing the atmospheric water harvester to water vapor in the atmosphere for a period of time and then mechanically removing the captured water from the atmospheric water harvester after the period of time. The hygroscopic polymer and the hydrophobic and elastic matrix can be made of the materials described herein, namely chitosan and silica xerogel, respectively. Further, the period of time to which the atmospheric water harvester is exposed to the water vapor in the atmosphere can range from hours to days. In a particular embodiment, the period of time ranges from 1 day to 30 days, and includes all of the individual days found therebetween.

AWH preparation

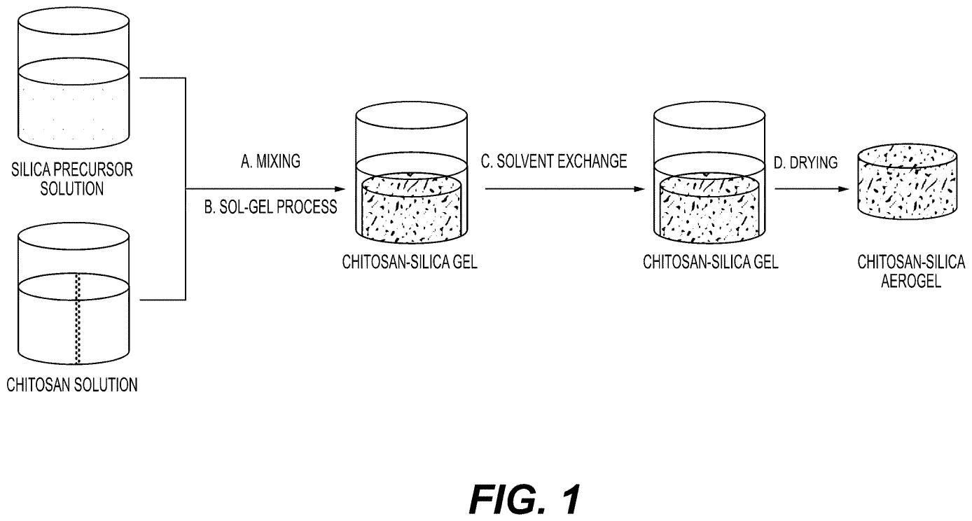

In a non-limiting example, the chitosan-silica xerogel of the atmospheric water harvester was synthesized in the following steps, as shown in FIG. 1. The first step was to prepare a chitosan solution by mixing 0.1 g chitosan (from Sigma-Aldrich) with a solution comprising 3.6 ml deionized water and 0.03 ml hydrochloric acid (≥37%, from Honeywell) to form a mixture. The mixture was stirred with magnetic stirring for 24 hours.

Then, the silica precursor solution was prepared. 15.6 mg of malonic acid (99%, from Sigma-Aldrich) was fully dissolved in 15 ml of deionized water. To this malonic acid aqueous solution, 4.0 ml of cetyltrimethylammonium chloride (25% wt. % in H2O, from Sigma-Aldrich), 5.4 ml of triethoxymethylsilane (99%, from Sigma-Aldrich) and 2.0 ml of dimethyldimethoxysilane (95%, from Sigma-Aldrich) were added and stirred for 15 minutes to allow for hydrolysis. After stirring 4.5 g of urea (≥98%, Sigma-Aldrich) was further added under stirring for 10 minutes. Subsequently, the as-prepared chitosan solution was added to the mixture and stirred for another 10 minutes.

After stirring for 10 minutes, the solution was transferred to a vessel, sealed, and kept at 70° C. for 12 hours for gelation and aging, thus forming a wet gel. The obtained wet gel was washed with 100 ml deionized water five times and 100 ml ethanol (96%, VWR) twice to remove any unreacted reagents. The washed wet gel was then slowly dried at 50° C. under ambient pressure for 24 hours to form the chitosan-silica xerogel with the chitosan embedded in the silica xerogel matrix.

In another embodiment, the silica xerogel (without chitosan) and the chitosan-silica xerogel with higher chitosan concentration were synthesized, named chitosan (high)-silica xerogel. The silica xerogel was prepared with the same procedures as that of chitosan-silica xerogel but without adding the chitosan solution. The chitosan (high)-silica xerogel was prepared by adding 0.5 g chitosan, 18 ml deionized water, and 0.15 ml hydrochloric acid to the same amount of silica precursor solution used for the chitosan-silica xerogel.

### Chitosan-Silica Xerogel Characterization

The microscale morphology of chitosan-silica xerogel was observed under a JEOL JSM-7100F scanning electron microscope (SEM). The elemental analysis and mapping were conducted via Inca X-max 50 energy dispersive X-ray spectroscopy (EDXS). Before doing SEM and EDXS, gold was sputtered on the xerogel with a thickness of 10-14 nm to enhance the electrical conductivity of the sample surface using the Emitech K575x sputter coater. The functional groups of the samples were investigated by Bruker Vertex 70 Hyperion 1000 Fourier-transform infrared spectroscopy (FTIR) via the KBr pellet method. The wettability of the test samples was characterized by the contact angles of sessile water droplets, which was conducted on a Biolin Theta contact angle goniometer. The sessile droplet volume used for each measurement was 5+0.2 μl, and five different sites on the xerogel surface were tested to get the average result and the error. The elasticity of xerogels was measured by uniaxial compression test using Instron 5567 H1540 Model. For the compression test, the xerogels were cut into a cylindrical shape with 5.99 mm in height and 11.02 mm in diameter and were compressed to 50% of their height at a rate of 0.02 mm/s.

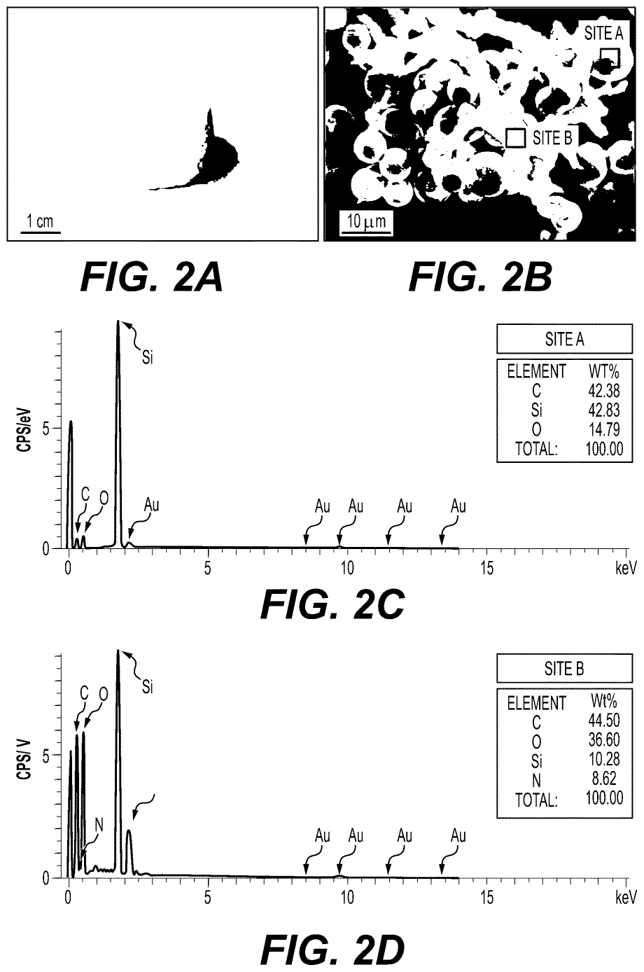

The as-prepared chitosan-silica xerogel monolith in this work is presented in FIG. 2(a), which is a porous white material. The SEM image in FIG. 2(b) shows the microscale morphology of the chitosan-silica xerogel, a combination of spherical particles with a diameter of 7±2 μm and particles with irregular shapes.

Further characterization was accomplished through an elemental analysis of the two components of the xerogel through EDXS measurement. The spherical particles (site A) consist of C, O, and Si (see FIG. 2(c)), indicating that it is made of organosilanes. While the irregular part is made of chitosan polymer, because an additional N peak was observed on the EDXS spectra of site B (see FIG. 2(d)) belonging to the amino groups of chitosan. Note that the small amount of Si element detected on the chitosan polymers (site B) should be caused by the underlying silica particles, and the Au element observed on both sites A and B was introduced by the sputtering process to enhance the electrical conductivity of the sample surface. Therefore, the atmospheric water harvester developed in this work is made of interconnected silica particles forming the porous and elastic matrix and chitosan polymer dispersed among the gaps of silica particles.

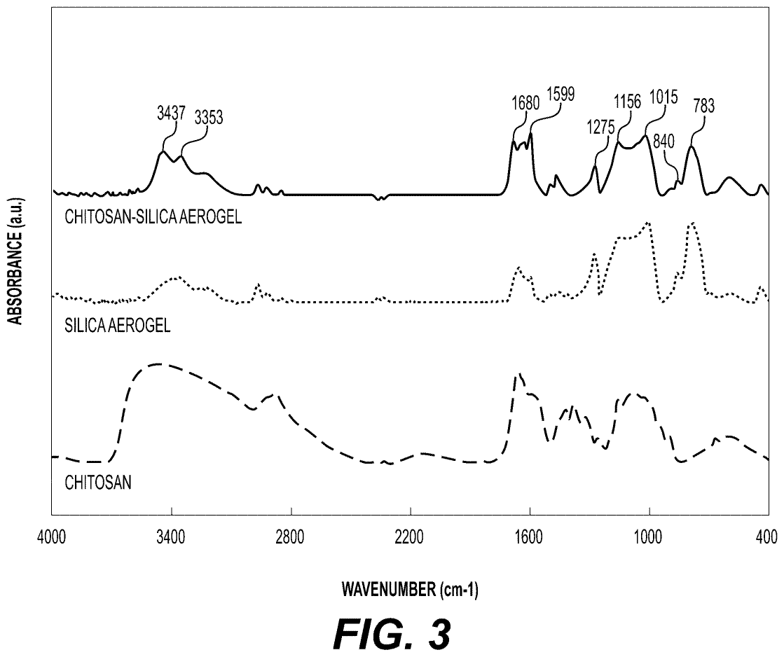

FTIR was further used to analyze the functional groups of the chitosan-silica xerogel. FIG. 3 shows the infrared spectrum of chitosan-silica xerogel and the spectra of chitosan and silica xerogel used as references. The absorption bands at 3437 cm⁻¹, 1680 cm⁻¹, 1599 cm⁻¹, and 1156 cm⁻¹ are attributed to the N—H and O—H stretching, the N—H bending of the primary amine, the C—C stretching, and the C—O—C asymmetric stretching of chitosan [21, 22]. The band at 3353 cm⁻¹ corresponds to the Si—OH stretching, and the bands at 1015 cm⁻¹ and 783 cm⁻¹ correspond to symmetric vibration and asymmetric stretching of Si—O—Si, which indicate the hydrolysis and polymerization of silica monomers [23-26]. The prepared silica particles are hydrophobic as suggested by the vibration of C—H and Si—C bonds of —Si—CH₃ units proved by the peaks at 1275 cm⁻¹ and 840 cm⁻¹, respectively.

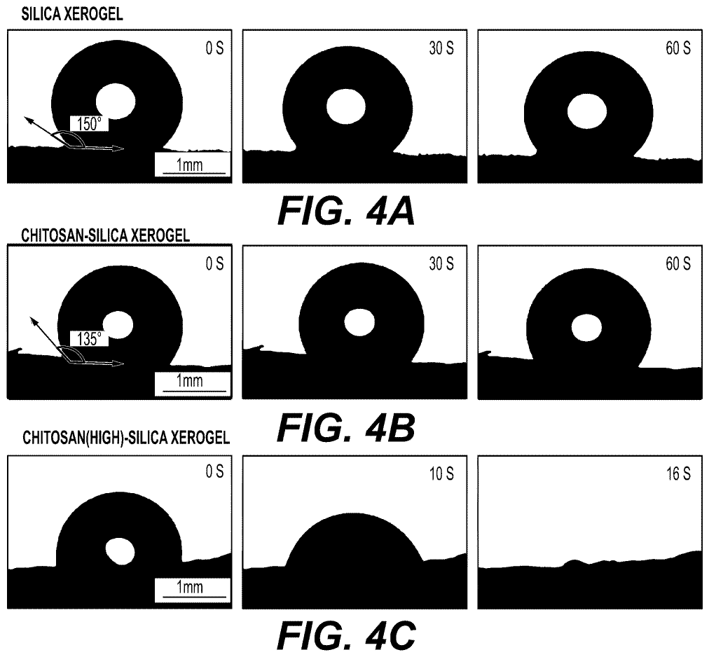

The wettability of silica xerogels with different chitosan concentrations is summarized in FIG. 4, characterized by the sessile water drop method. As proved by the FTIR result, the silica xerogel was hydrophobic with a water contact angle of 149±3° (see FIG. 4(a)). After adding chitosan, the chitosan-silica xerogel sample was still hydrophobic but with a lower water contact angle (136±2°) than silica xerogel (see FIG. 4(b)). With a five times higher amount of chitosan added, the dispensed water droplet first sat on the chitosan (high)-silica xerogel with a contact angle of 105°, but gradually wetted and was fully sucked in the xerogel after 16 s as shown in FIG. 4(c). This is because the hydrophobicity of the silica matrix resists the water droplet penetration while the hydrophilicity of chitosan attracts the water, resulting in the wetting transition phenomenon of a water droplet on the chitosan (high)-silica xerogel.

The elastic properties of the various xerogels were tested. The silica xerogel was elastic which can spring back after compression. After adding lower amount of chitosan, the prepared chitosan-silica xerogel was still flexible. However, with higher amount of chitosan, the chitosan (high)-silica xerogel became rigid and broke down after compression.

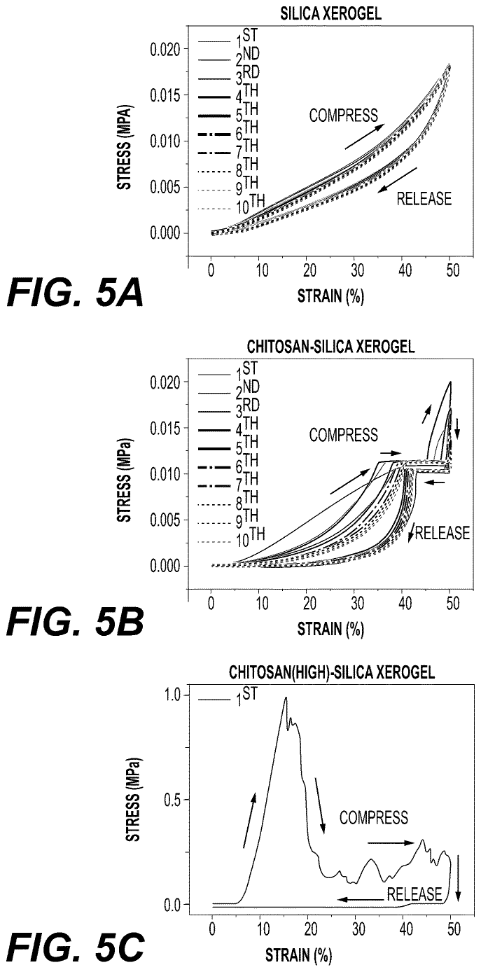

We further quantified the elastic properties of xerogels by the uniaxial compression test (FIG. 5). A typical measurement cycle included compressing and then releasing of the xerogel for ten cycles of compression/release. After being compressed by 50% of its height (50% strain), the silica xerogel can spring back 48% strain for the 1st cycle and 45% strain for the 10th cycle, indicating a stable elastic property. The chitosan-silica xerogel also performed stable elastic property recovering 45% strain for the 1st cycle and 41% strain for the 10th cycle after 50% compressive strain. There is an alteration in the mechanical properties of the chitosan-silica xerogel during the initial three compression cycles, after which it reaches a stable state. The platforms occurring when the strain was higher than 35% were due to the plastic deformation attributed to the loaded chitosan. Moreover, the small stress (<0.020 MPa) needed to compress the xerogel to 50% of its height implies low energy consumption for water squeezing. The chitosan (high)-silica xerogel collapsed after the 1st compression indicating that the chitosan concentration needs to be carefully controlled in a suitable range to maintain the elastic property of silica matrix.

Thus, the above characterizations show that the atmospheric water harvester, chitosan-silica xerogel, is a biphilic and elastic material consisting of hydrophilic hygroscopic polymer chitosan embedded within the hydrophobic silica matrix.

### Atmospheric Water Harvesting Test

In general, three steps were featured a typical atmospheric water harvesting cycle of the chitosan-silica xerogel: (i) the chitosan-silica xerogel captured water vapor when exposed to a humid atmosphere due to the function of hygroscopic chitosan; (ii) after 30 days, the xerogel was squeezed by mechanical force to release the liquid water and simultaneously achieve sorbent regeneration; (iii) the detained water confined in the matrix was released by low-grade heat (40° C.).

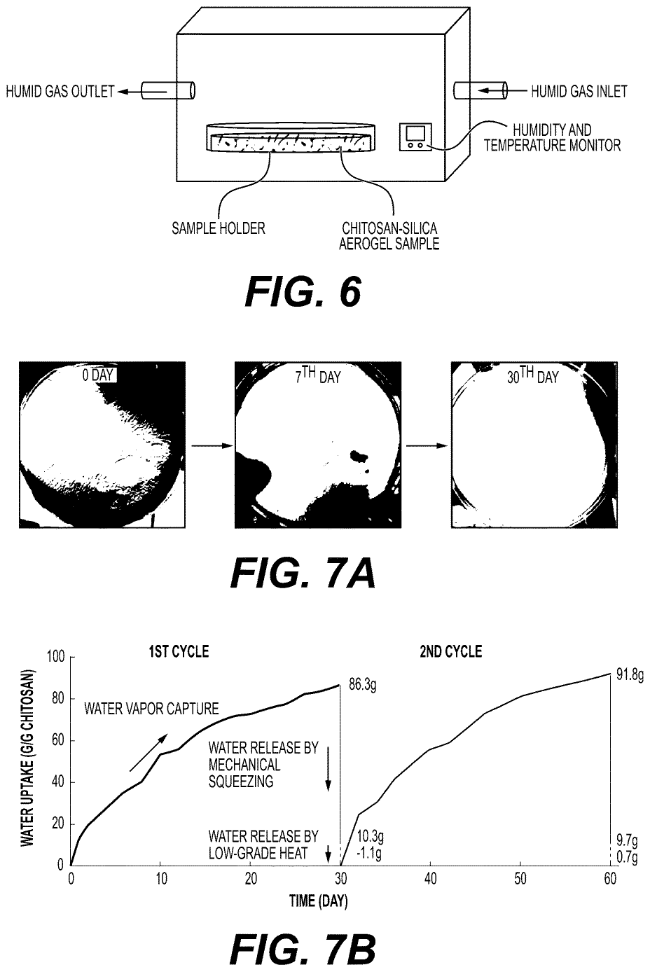

The particular chitosan-silica xerogel used for the water harvesting test was prepared in accordance with the above method. The chitosan-silica xerogel was in a round pad shape with a diameter of 9 cm and a thickness of 0.5 cm. The atmospheric water harvesting test was conducted inside an acrylic airtight chamber with a humid gas inlet and outlet, and a humidity and temperature monitor as shown in FIG. 6. Before starting the test, a stream of moist air was conducted to the chamber to control the relative humidity inside to 97% at 25° C. Then the chitosan-silica xerogel, along with the holder, was placed in the chamber. The total weight of the chitosan-silica xerogel and the holder was measured every two days. The difference between the weight measured and the original weight was the amount of water captured. After 30 days, the chitosan-silica xerogel was compressed by 50% of its height to release the water harvested. The detained water in the xerogel was further released by heating it at 40° C. for 2 hours. The regenerated chitosan-silica xerogel was put in the test chamber again to start the second cycle of water harvesting.

The water capturing progress of chitosan-silica xerogel was visible and shown in FIG. 7(a). The dried xerogel first got partially wetted on the 7th day and fully wetted on the 30th day. And the capturing process happened continuously during the 30 days proved by the steady increase of water uptake amount (see the water vapor capturing process of the 1st cycle in FIG. 7(b)). The slight decrease in water capturing rate (e.g., from the 20th day to the 30th day) is due to the coverage of hygroscopic area caused by the condensed water. After 30 days of water vapor sorption, the chitosan-silica xerogel harvested a total water amount of 86.3 g/g chitosan, with water capturing rate of 2.88 g/(g chitosan·day). Surprisingly, it was found that up to 88% of the total water captured can be quickly released by mechanical squeezing within 150 seconds due to the elastic and hydrophobic properties of the silica xerogel matrix. Note that the xerogel was only compressed by 50% to avoid breaking the xerogel during the mechanical squeezing process. The detained water (12%) in the matrix was due to the incomplete compression of the xerogel and the strong interaction between water molecules and chitosan, which can be optionally desorbed by heating at 40° C. for 2 hours. The reusability of the regenerated xerogel was also examined by performing a consecutive water capturing-releasing cycle (2nd cycle in FIG. 7(b)). The performance of the 2nd cycle did not present any capturing capacity loss with a total water harvested amount of 9.18 g after 30 days, 89% of which was released through mechanical squeezing. The stable water uptake and mechanical release capabilities of chitosan-silica xerogel indicate its potential in a long-term water harvesting operation.

The water harvesting performance of silica xerogel and chitosan (high)-silica xerogel were also tested under the same condition. Without hygroscopic material, the silica xerogel exhibited no water harvesting capability, while the chitosan (high)-silica xerogel demonstrated a better water capturing rate of 4.43 g/(g chitosan·day) than the chitosan-silica xerogel. However, the water harvested by the rigid chitosan (high)-silica xerogel could not be released by mechanical squeezing.

Thus, the present disclosure is directed to an atmospheric water harvester formed by integrating hygroscopic polymer chitosan with an elastic and hydrophobic silica matrix. The as-fabricated biphilic and flexible chitosan-silica xerogel demonstrated a water harvesting capability of 2.88 g/g chitosan/day. More importantly, 88% of the water harvested by the xerogel can be released by mechanical squeezing. This unique water release property enables the regeneration of chitosan-silica xerogel with less time and energy consumption. Coupled with the stable elasticity of the xerogel and the antimicrobial property of chitosan, the as-presented chitosan-silica xerogel provides a promising solution to achieve a long-term production of safe freshwater to alleviate water scarcity. Further development is needed to enhance the water sorption rate of the hygroscopic polymers and improve the mechanical strength of the hydrophobic matrix.

It is to be understood that the present subject matter is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. An atmospheric water harvester comprising:
a hygroscopic polymer; and
a hydrophobic matrix,
wherein the hygroscopic polymer is embedded in the hydrophobic matrix.

2. The atmospheric water harvester according to claim 1 wherein the hygroscopic polymer comprises chitosan.

3. The atmospheric water harvester according to claim 1 wherein the hydrophobic matrix comprises silica xerogel.

4. An atmospheric water harvester comprising:
chitosan; and
a silica xerogel matrix,
wherein the chitosan is embedded in the silica xerogel matrix.

5. A method of harvesting water from an atmosphere comprising:
providing an atmospheric water harvester in an atmosphere, wherein the atmospheric water harvester comprises:
a hygroscopic polymer; and
a hydrophobic matrix, wherein the hygroscopic polymer is embedded in the hydrophobic matrix;
capturing water on the hygroscopic polymer by exposing the atmospheric water harvester to water vapor in the atmosphere for a period of time; and
mechanically removing the captured water from the atmospheric water harvester after the period of time.

6. The method according to claim 5 wherein the hygroscopic polymer comprises chitosan.

7. The method according to claim 5 wherein the hydrophobic polymer comprises silica xerogel.

8. The method according to claim 5 wherein the period of time is between 1 day and 30 days.
